(19) United States
(12) Patent Application Publication
(10) Pub. No.: US 2011/0226698 A1
(43) Pub. Date: Sep. 22, 2011

(54) Dynamic Filtration

(76) Inventors: Abdulsalam AL-MAYAHI, Surrey (GB); Mohammed Aljohani, Jeddah (SA)

(21) Appl. No.: 12/950,985

(22) Filed: Nov. 19, 2010

Related U.S. Application Data
(60) Provisional application No. 61/262,609, filed on Nov. 19, 2009.

(51) Int. Cl. C02F 1/44; B01D 63/10; C02F 103/08

(52) U.S. Cl. 210/651; 210/650; 210/780; 210/359; 210/402; 210/138

(57) ABSTRACT

A novel dynamic filtration method and apparatus reduce the bio fouling and the scaling on the membrane surface during separation processes. A membrane separator is rotated while receiving feed to be separated into a component and waste. Because of the reduction in bio fouling and scaling on the membrane surface, the useful lives of RO and NF membranes may increase significantly, along with energy savings.

### RELATED APPLICATIONS

This application claims priority to U.S. Provisional Patent Application 61/262,609 entitled “Dynamic Filtration” filed Nov. 19, 2009, which is incorporated by reference in its entirety.

### FIELD OF THE INVENTION

The invention relates to separation technologies and, more specifically, to systems and methods for rotating membrane separators during operation.

### BACKGROUND

Separation processes such as reverse osmosis (RO) use pressure to force a solvent through a semi-permeable membrane that retains most of solutes on one side and allows the solvent to pass to the other side. More formally, reverse osmosis is the process of forcing a solvent from a region of high solute concentration through a semi-permeable membrane to a region of low solute concentration by applying an external pressure in excess of the osmotic pressure difference between the two sides of membrane. Osmotic pressure is the pressure that must be applied to a solution to prevent the inward flow of water across a semi-permeable membrane.

The membranes used for reverse osmosis have a dense barrier layer in the polymer matrix where most separation occurs. In most cases, the membrane is designed to allow only water to pass through this dense layer while preventing the passage of solutes (such as salt ions). This process requires that a high pressure be exerted on the high concentration side of the membrane, usually 40-80 bars for seawater, which has around 24 bars natural osmotic pressure that must be overcome. This process is best known for its use in desalination, i.e., removing the salt from seawater to get fresh potable water.

Typically a spiral wound RO membrane is used in seawater and brackish water desalination processes. In the spiral wound system, alternating layers of feed spacer material, membrane sheets, and permeate carrier, possibly along with a fabric support layer, are rolled into a spiral configuration. See FIG. 1. These rolls are placed in a pipe profile called a pressure vessel. The membrane construction is in such a way that it contains a module that separates a feed water into a permeate water and a concentrate water (also called reject water). The membrane contains a bridge-type filament inside of it. The function of this filament is simply to form a spacer which runs parallel to the flow direction so that the spacer functions as a single, continuous sheet spacer material, within the feed flow channel of the spirally wound membrane module.

During a purification process for seawater or brackish water using an RO membrane, the pressurized feed enters one side of the pressure vessel and flows through a stationary membrane that is firmly fixed in the pressure vessel. Reject water will be collected from the other side separately in the outlet, and permeate is collected separately from the center of other side as well. As the membrane is a stationary element, the scaling or bio-fouling takes place because of constituents in the seawater or brackish water that over a period of time forms a non-desirable layer of scales or foulants. The major problems faced in the reverse osmosis process can be grouped as “scaling” and “fouling”.

The “scaling” problem includes certain salts and other impurities clogged the membrane. Over a period of time, scaling is developed. These accumulated impurities hinder the process of reverse osmosis and reduce the rate of output.

The “fouling” problem can affect membrane performance, in some cases, permanently. Fouling may be composed of materials adsorbed directly on the membrane, or may accumulate on the surface, where it is difficult to control. In general, fouling is a boundary layer, or sub-boundary layer, phenomenon, caused, or aggravated, by concentration polarization, in which solutes deposit on the membrane surface and reduce membrane flux and selectivity. The mechanisms of deposition may include chemical reaction, precipitation, electrical attraction, and other interactions. Whereas concentration polarization is a fluid dynamics phenomenon, fouling is a chemical phenomenon between solutes and the membrane. Foulants may include, but are not limited to, organic salts, macromolecules, colloids, and microorganisms.

Scaling and fouling problems affect the life of the membrane. They warrant the removal of the membrane for cleaning/replacement. Removal, cleaning, and re-assembly of the membrane system may lead to down time in production Frequent replacement of the membrane may add cost as well as increase in downtime

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 shows a spiral wound membrane for use with various embodiments of the present invention;

FIG. 2 shows front view of the assembly, shown in section, according to various embodiments of the present invention;

FIG. 3 shows an isometric sectional view of the assembly according to various embodiments of the present invention;

FIG. 4 shows an isometric sectional view of inlet side in the assembly according to various embodiments of the present invention;

FIG. 5 shows an exploded view of the assembly showing various parts, according to various embodiments of the present invention;

FIG. 6 shows an isometric view of the turbine blade according to various embodiments of the present invention;

FIG. 7 shows front view of the assembly, shown in section, according to various embodiments of the present invention;

FIG. 8 shows an isometric sectional view of the assembly c according to various embodiments of the present invention;

FIG. 9 shows an isometric sectional view of inlet side in the assembly according to various embodiments of the present invention;

FIG. 10 shows an exploded view of the assembly showing various parts, according to various embodiments of the present invention;

FIG. 11 shows front view of the assembly, shown in section, according to various embodiments of the present invention;

FIG. 12—shows an isometric sectional view of the assembly considered for the third embodiment of the present invention; and

FIG. 13 shows an exploded view of the assembly showing various parts, according to various embodiments of the present invention.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Moreover, the use of “top,” “bottom,” “above,” “below,” and variations of these terms is made for convenience, but does not require any particular orientation of the components.

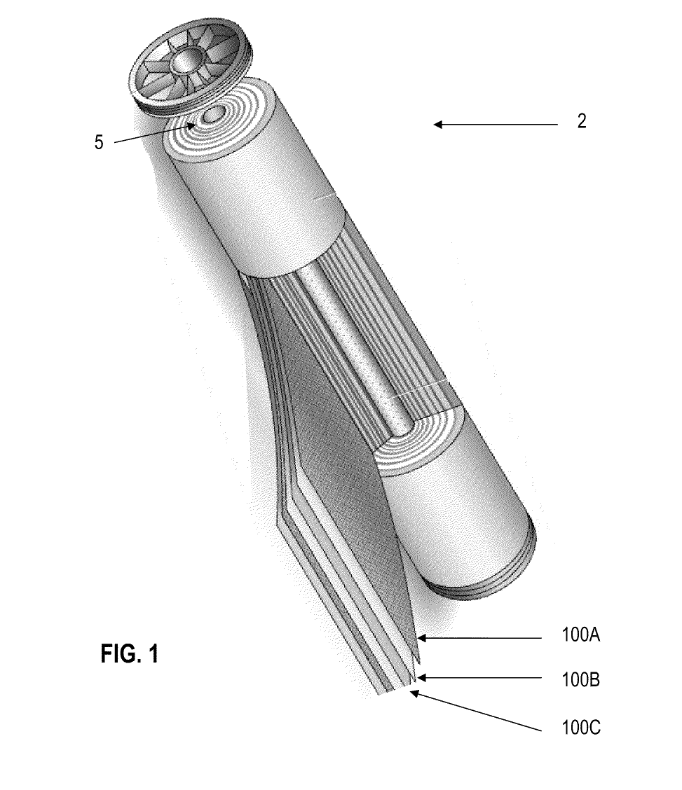

Turning now to the figures, FIG. 1 shows a spiral wound membrane 2 that is used in the preferred embodiment of the present invention. The inlet 3 is where the feed is supplied. The desired component of the feed solution is typically received at outlet 5, while the waste stream is received at reject outlet 4. Note that the spiral wound membrane 2 is typically composed of a plurality of layers, 100A, 100B, 100C, etc. The various layers 100 may include a membrane layer, a feed flow layer, an outlet layer, a support layer, etc. Other membrane configurations are also contemplated.

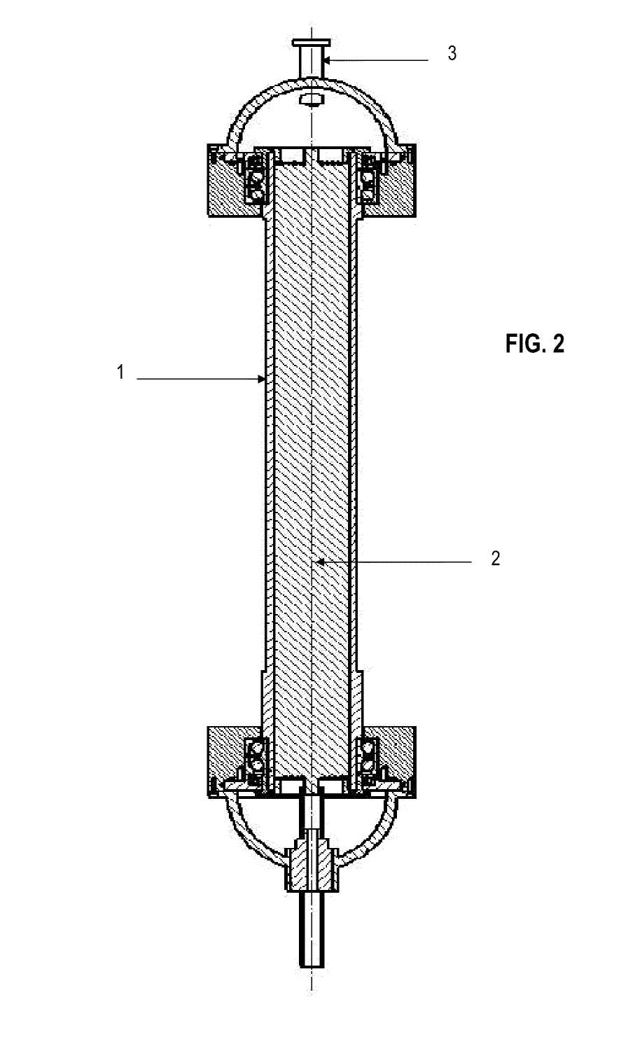

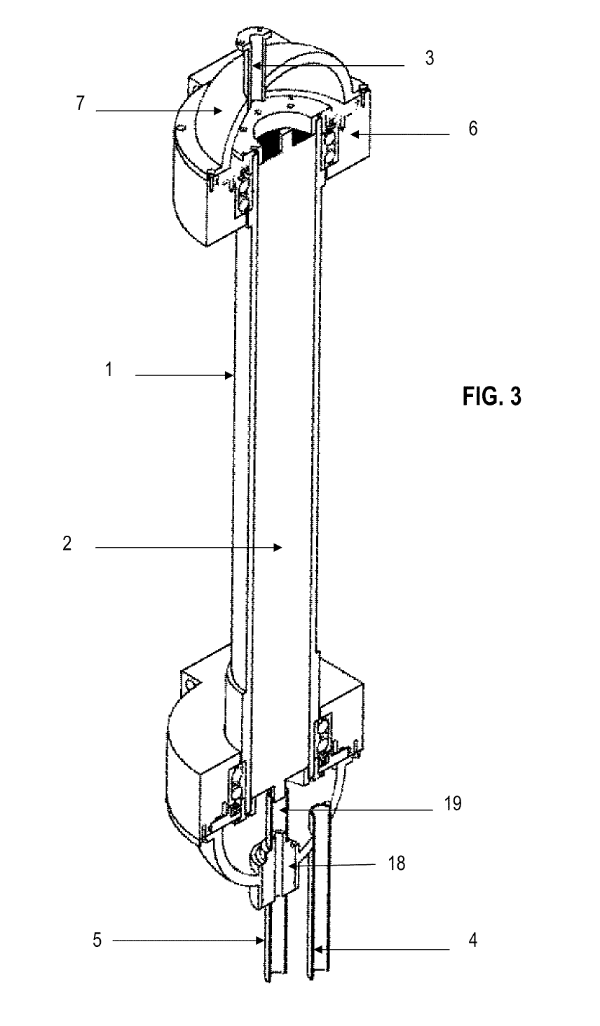

Turning to FIGS. 2 and 3, according to various embodiments of the present invention, in an effort to overcome the above related problems of scaling and bio-fouling, i.e., to reduce scaling, reduce fouling, and to increase the efficiency and life of membrane, a dynamic filtration method and apparatus for the spiral wound membrane 2, which may be an RO or NF membrane, along with a housing 1 (the housing is a pressure vessel) will rotate with reference to its center axis during the separation (or filtration) process. The rotary movement may be achieved by various aspects as explained below.

According to one desalination embodiment of the present invention, where the spiral wound membrane is an RO membrane, the RO membrane 2, along with the housing 1, is rotated by the energy developed by the of the inlet feed water pressure and according to the spiral arrangement of water flow inside the membrane.

Because of the spiral wound profile of the membrane 2, once the pressurized water enters the membrane, the water will pass through the spiral path of the membrane. This will create a momentum for rotation as the membrane 2 along with housing 1 is preferably mounted on bearings 12 that tend to rotate. The bearings 12 have stationary outer rays and rotating inner rays in-between ground balls to facilitate smooth rotation. The inner rays are connected to the housing 1 shown in FIG. 2. Both the housing 1 and the membrane 2 are the rotatable parts.

As an example, sea water may be forced into the housing 1, with a maximum of 80 bar pressure in one embodiment, onto the membrane 2 by means of an inlet pipe 3. This in turn rotates the membrane 2 along with the housing 1. This means the housing 1 and the membrane 2 start rotating due to the pressure created by the force of the inlet feed water.

Once the housing assembly starts to rotate, it will keep rotating as long as the inlet fluid is being supplied under pressure. Inlet and outlet pressure chambers 7, which are preferably stationary items, are designed to withstand the pressure and also will maintain the pressure created inside it without any pressure loss as it is a closed construction with mounting arrangements on its collars.

During this dynamic filtration process, seawater or brackish water may be purified, and purified water will come out through the purified water outlet (permeate) 5. A rotary joint 18 connecting pipe 19 may be used to connect the rotating purified water outlet 5 and the outlet pressure chamber 7. The rejected water will be collected through the reject water outlet 4. Due to the rotation of the membrane 2 along with housing 1, the salts and impurities will preferentially not get clogged on the membrane 2. During rotation, to prevent the water leaking, a seal 15, a spacer 16, and a face seal 17 may be provided on both the inlet and the outlet of the system. The bearing housing 6, inlet and outlet pressure chambers 7, inlet pipe 3, and reject water outlet 4 are preferably stationary elements in the system.

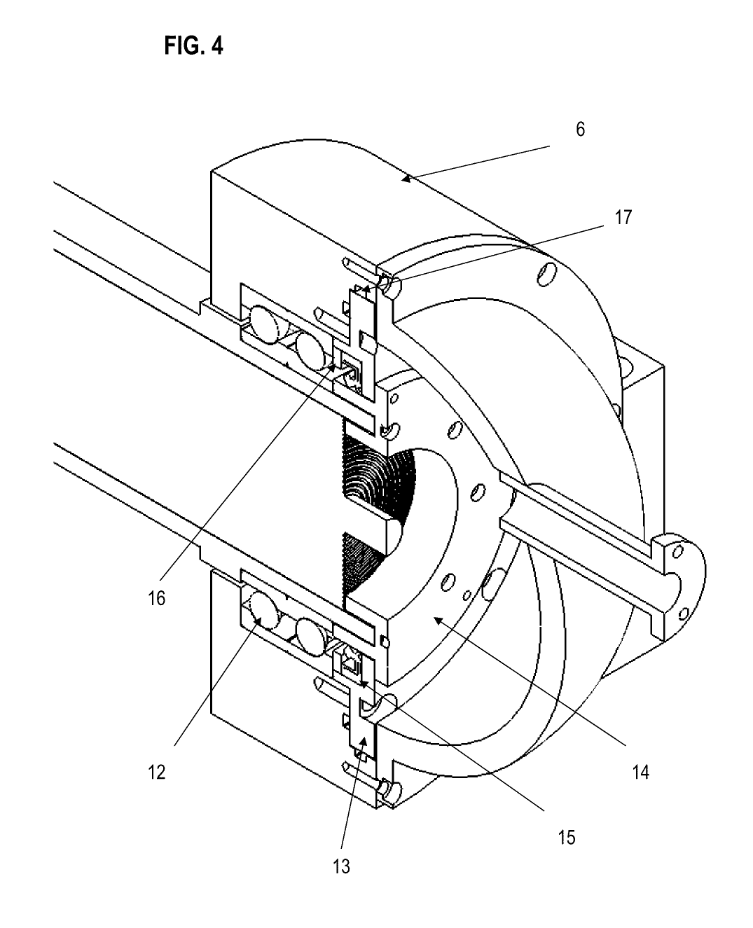

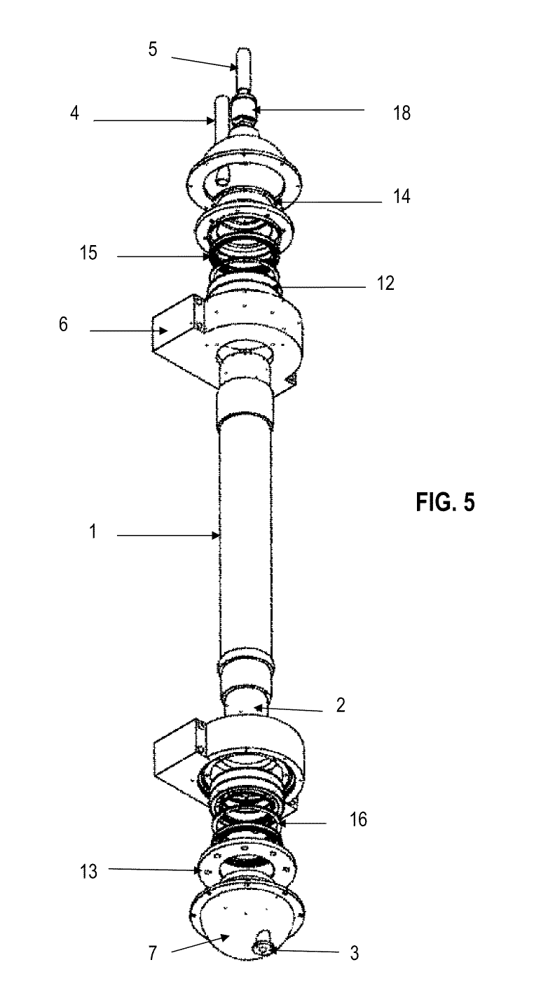

The bearing housing 6 may act as a closed enclosure for bearings 12, seals 15, spacers 16, and the face seal 17, as shown in FIG. 4. Bearing housing 6 is prefereably a stationary part in the system. In the illustrated embodiment, bearings have been provided on the two ends to facilitate smooth rotation of the membrane 2 and the housing 1. Bearings 12 are preferably the main rotating part of the system.

Bearings are machine parts designed to reduce friction between moving parts, or to support and to guide moving loads. A ball bearing consists of an inner race, an outer race, steel balls, and end seals. Ball bearings are usually found in light precision machinery where high speeds are maintained, friction being reduced by the rolling action of the hard steel balls. Antifriction bearings preferably include the ability to operate at high speeds and easy lubrication. In the bearing, the balls, or rollers, are caged in an angular grooved track, called a race, and the bearings are held in place by a frame, commonly called a pillow block or Plummer block.

An end cap 13 has been provided for holding the bearings 12 in position while rotating. This end cap 13 is preferably a stationary part in the system, and it acts as a retainer for bearings 12. The end cap 13 will press the outer race of the bearing 12, and the inner race is supported by means of a step provided on the housing 1.

Seals 15 are acting as a covering for bearings to prevent them from getting contaminated by the working solvent (e.g., water) and solute particles. Seals 1) are preferably stationary parts in the system. Mechanical seals are designed to prevent leakage between a rotating shaft and its housing under conditions of extreme pressure, shaft speed, and temperature. The seals 15 may include multiple small springs made up of stainless steel garter material inside. Multiple small springs are not as susceptible to distortion at high speeds as are single coil springs, and they consequently exert an even closing pressure on the seal ring at all times. A spacer 16 may be used to separate the bearing 12 and the seal 15. Spacer 16 is preferably a stationary part in the system. A membrane retainer 14 may be provided for the membrane 2, to prevent it from coming out of the housing 1 while rotating.

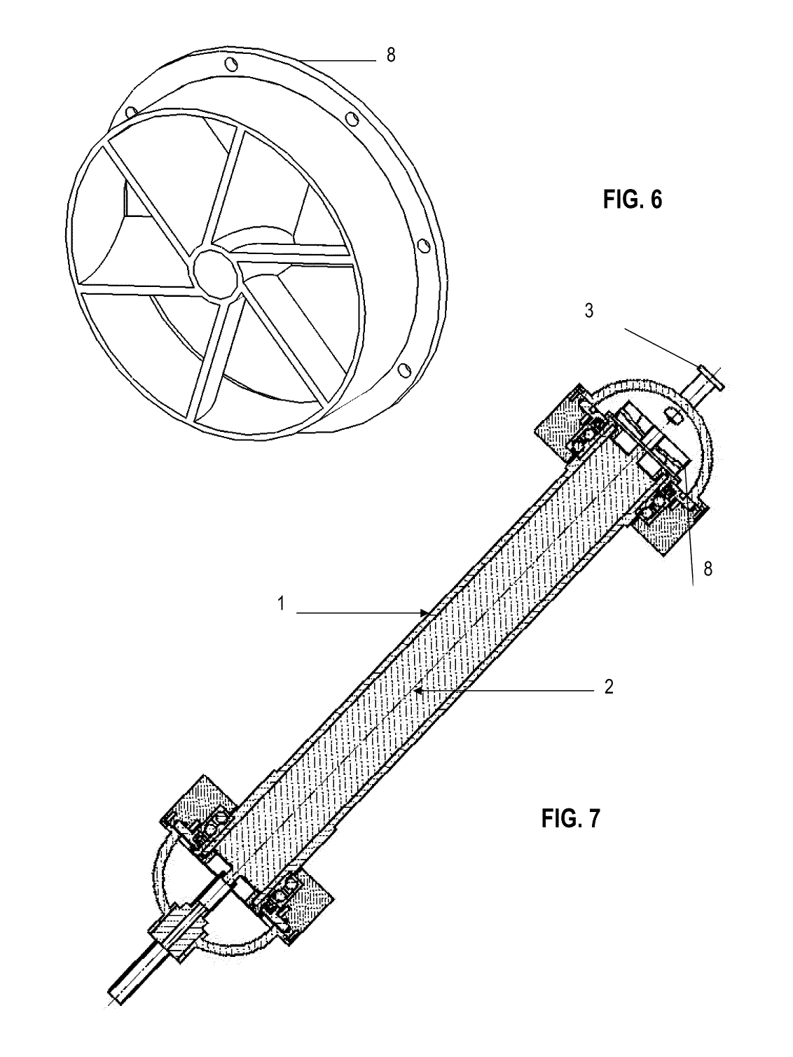

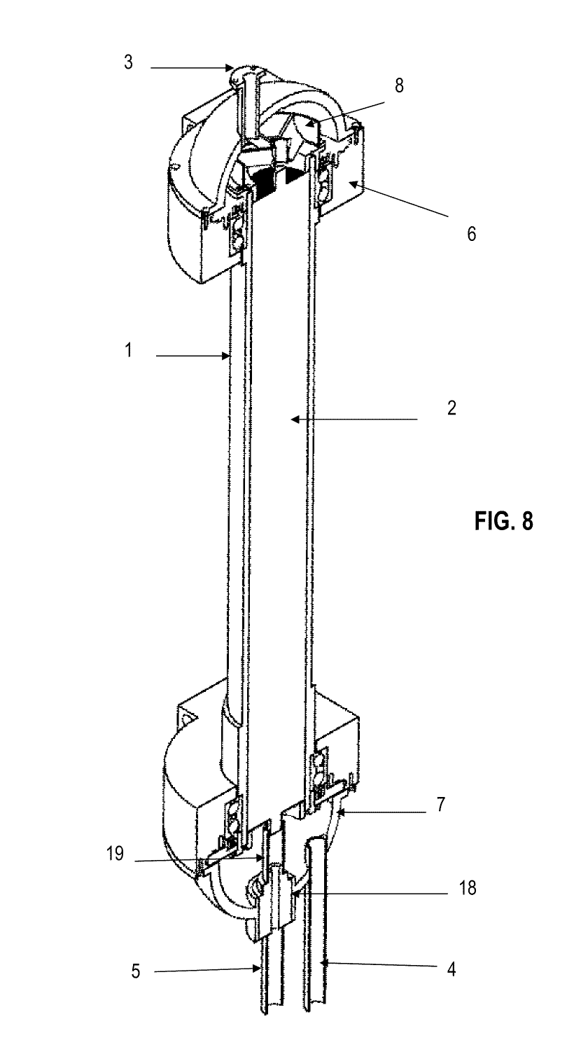

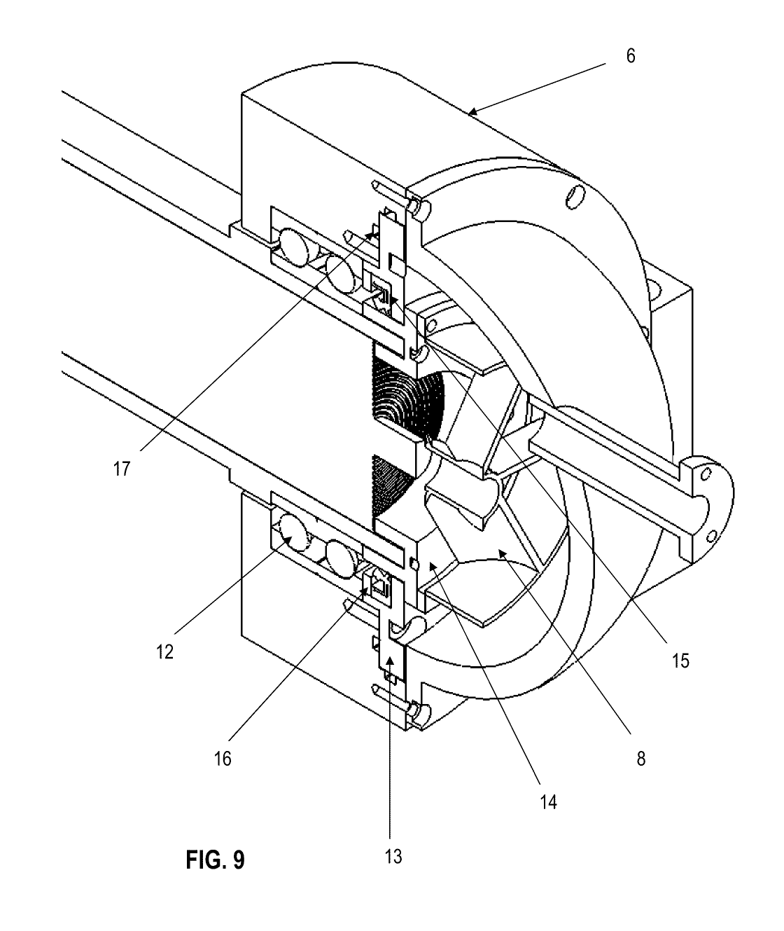

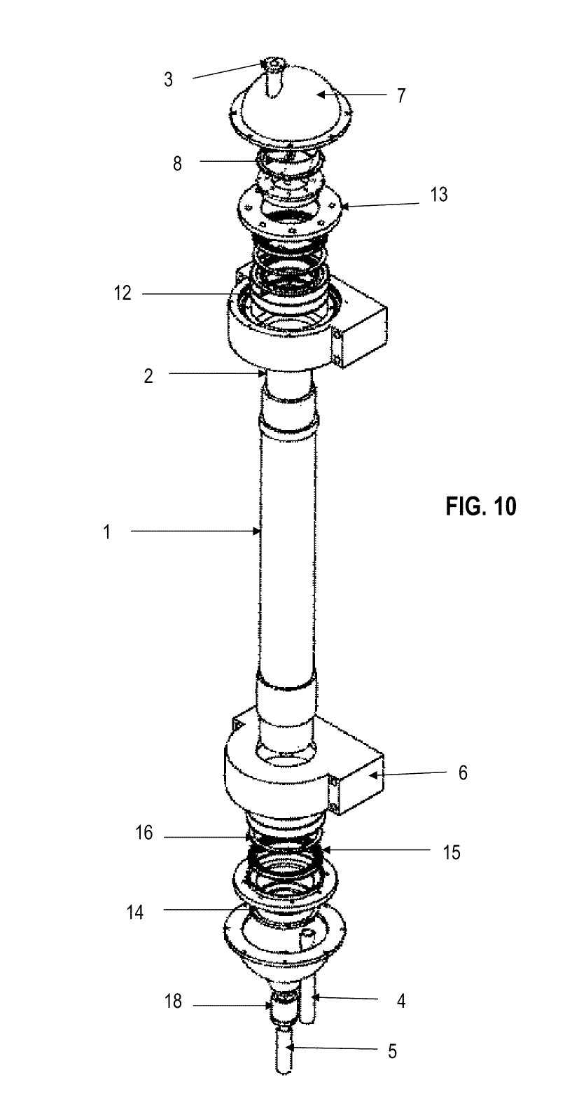

Turning to FIG. 6, according to various other embodiments of the present invention, the membrane 2 along with the housing 1 may be rotated by the energy developed by the inlet water pressure on a turbine blade 8. In one embodiment, the turbine blade 8 has a geometric shape similar to a Pelton turbine blade 8. The process remains otherwise similar to the earlier embodiments of the present invention with cross reference to FIGS. 6-10. The inlet pressurized water falling on the turbine blade 8 will provide momentum for rotation. Turbine blade 8 may be mounted onto the face of the housing 1 at the inlet side.

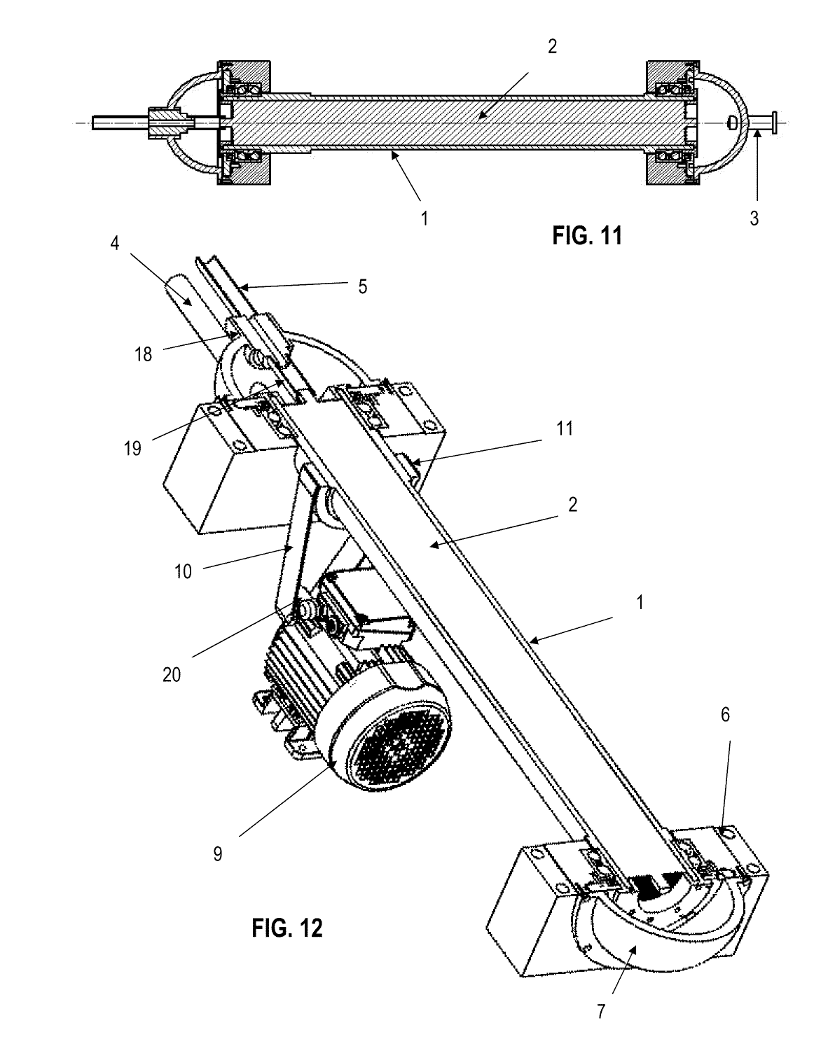

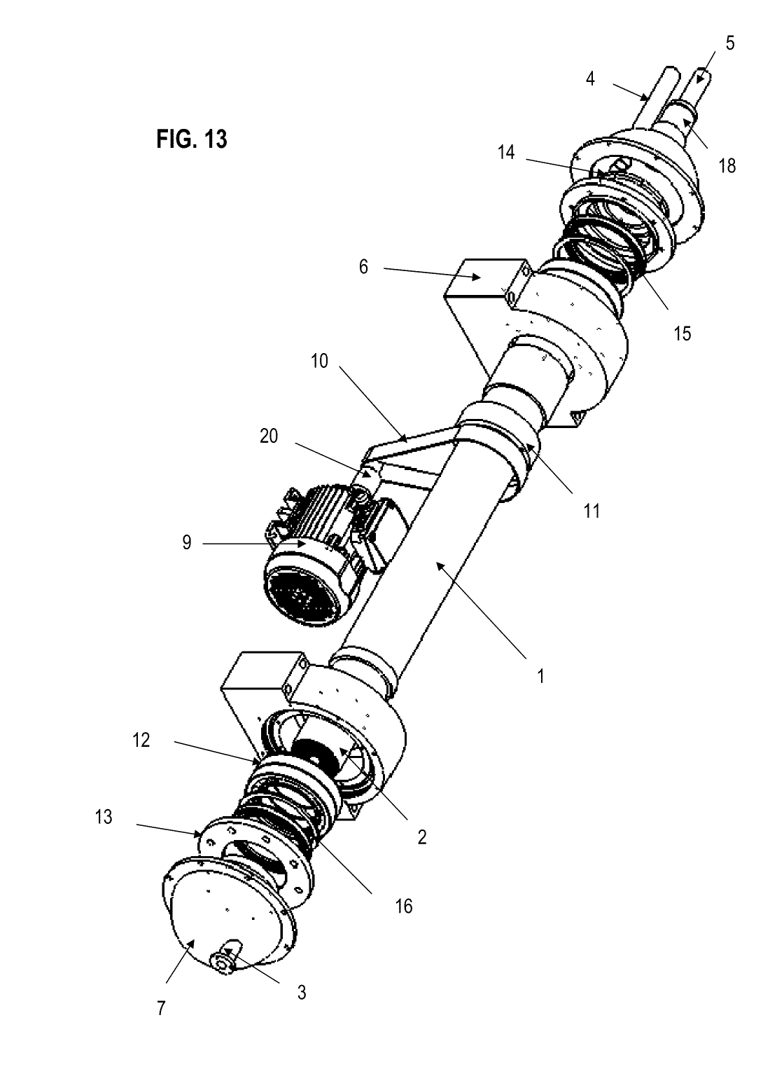

Turning to FIG. 11, according to various other embodiments of the present invention, the membrane 2 along with the housing 1 may be rotated by an external motor 9, either along with the inlet water pressure or against it. The process remains otherwise similar to the earlier embodiments of the present invention with cross reference to FIGS. 12-13. Rotation of membrane 2 along with housing 1 will take place from the combined force of the inlet pressurized water falling on the membrane 2 and the external drive from the motor 9, such as through a motor pulley 20, a housing pulley 11, and a belt 10, as illustrated.

According various other embodiments of the present invention, multiple membranes 2 along with the long housing may be rotated by the external motor 9 and inlet water pressure. The process otherwise remains similar to the other embodiments of the present invention. Multiple membranes may enclosed in one long single housing with intermediate bearing housing support. Rotation of membranes 2 along with long housing will take place once the inlet pressurized water falls on the membrane 2 and prefereably with external drive from motor 9 through motor pulley 20, housing pulley 11, and belt 10.

In other embodiments, the belt 10 and pulley system 11 and 20 may be replaced with a planetary gear system instead of the belt drive. Rotation of membrane 2 along with long housing will take place once the central gear starts rotating by external motor 9.

According to various other embodiments of the present invention, the membrane 2 along with the housing 1 may be rotated by the external motor 9 clockwise and anticlockwise directions alternately. The process remains otherwise similar to the other embodiments of the present invention except for altering the direction of rotation either intermittently or periodically.

According to various other embodiments of the present invention, the membrane 2 may be other types of membreanes other than RO and NF membranes. Any spiral wound-type membrane is contemplated, such as are used in microfiltration (MF) or ultrafiltration (UF) processes. Some of these processes are referred to as separations, while others are referred to as filtrations. As used herein, the term separation includes separations, filtrations, and RO.

According to various other embodiments of the present invention, all other embodiments of the present invention may be used with any pressure-driven (solvent removal process) in place of desalination. Many pharmaceutical or industrial applications in which spiral wound membranes are used are known.

Generally speaking, the methods disclosed herein include a method of separation comprising providing a feed to a membrane separator and rotating the membrane separator while providing the feed. The methods may also include removing from the membrane separator at least one component, such as pure water in the case of RO, of the solution and removing from the membrane separator a remaining waste solution from the membrane separator. The methods may also include providing the waste solution to a second membrane separator and rotating the second membrane separator while providing the waste stream from the first membrane separator.

The methods may also include providing the solution to a spiral wound membrane separator and rotating the spiral wound membrane separator while providing the solution to the spiral wound membrane separator. The methods may also include rotating the spiral wound membrane separator while providing the solution to the spiral wound membrane separator in a direction opposite a winding direction of the spiral wound membrane separator.

The methods may also include rotating the membrane separator using momentum from the motion of the solution, using a turbine blade attached to the membrane, and using a motor attaching via a belt or gears. Any, any combination, or all are contemplated. One way of rotating the membrane separator may rotate one direction and another way may rotate the opposite direction.

According to various embodiments of the present invention, a method of separation may include rotating the separator a first direction during a first period while d providing the solution and rotating the separator an opposite direction from the first direction during a second period while providing the solution. The methods may alternate the direction of rotation between the first direction and the opposite direction on a periodicity or intermittently.

A method for desalinating water is also disclosed, including providing salt-contaminated feed to a desalination apparatus including a membrane, rotating the desalination separator during said providing, removing permeate water from the desalination separator; and removing reject water from the separator.

Due to rotation of the pressure vessel that contains the membrane, the formation of scaling on membrane surface may be reduced to large extent. Due to rotation, the rate of output rate may increase compared to a high resistance (low permeability) static membrane. Due to rotation, shear occurs between particles, which may play a major role in the anti-fouling mechanism.

With the above effects, the life of the spiral wound membrane may increase significantly, and a lower rate of power usage may be required to operate the process. Less chemical treatment efforts may be used, especially in the pre-treatment stage. Lesser amounts of added treatment chemicals (additives) such as anti-scalants or anti-fouling may be used. Also, maintenance downtimes may be reduced.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the scope of the invention as defined by the following appended claims.

1. A method of separation, the method comprising:
providing a solution to a membrane separator; and
rotating the membrane separator during said providing.

2. The method of claim 1, further comprising:
removing from the membrane separator at least one component of the solution; and
removing from the membrane separator a remaining solution from the membrane separator.

3. The method of claim 2, further comprising:
providing the remaining solution to a second membrane separator; and
rotating the second membrane separator during said providing the remaining solution.

4. The method of claim 1, wherein said providing the solution to the membrane separator comprises providing the solution to a spiral wound membrane separator; and
wherein said rotating the membrane separator during said providing comprises rotating the spiral wound membrane separator during said providing the solution to the spiral wound membrane separator.

5. The method of claim 4, wherein said rotating the spiral wound membrane separator during said providing the solution to the spiral wound membrane separator comprises rotating the spiral wound membrane separator during said providing the solution to the spiral wound membrane separator in a direction opposite a winding direction of the spiral wound membrane separator.

6. The method of claim 1, wherein said rotating the membrane separator during said providing further comprises rotating the membrane separator during said providing using momentum from the motion of the solution.

7. The method of claim 1, wherein said rotating the membrane separator during said providing further comprises rotating the membrane separator during said providing using a turbine blade connected to the membrane separator, wherein the turbine blade rotates due to impact from the solution.

8. The method of claim 1, wherein said rotating the membrane separator during said providing further comprises rotating the membrane separator during said providing using a motor.

9. The method of claim 1, wherein said rotating the separator during said providing further comprises rotating the separator during said providing using two or more of the group consisting of: momentum from the motion of the solution, a turbine blade connected to the separator, wherein the turbine blade rotates due to impact from the solution, and a motor.

10. A method of separation, the method comprising:
providing a solution to a separator; and
rotating the separator a first direction during a first period of said providing; and
rotating the separator an opposite direction from the first direction during a second period of said providing.

11. The method of claim 10, further comprising:
alternating the direction of rotation between the first direction and the opposite direction on a periodicity.

12. The method of claim 10, wherein said rotating the separator the first direction during the first period of said providing further comprises rotating the separator the first direction during the first period of said providing using a first way; and wherein said rotating the separator the opposite direction from the first direction during the second period of said providing further comprises rotating the separator the opposite direction from the first direction during the second period of said providing using a second way, wherein the first way and the second way are selected from the group consisting of: momentum from the motion of the solution, a turbine blade connected to the separator, wherein the turbine blade rotates due to impact from the solution, and a motor.

13. The method of claim 12, wherein the first way and the second way are identical ways.

14. A method for desalinating water, the method comprising:
providing salt-contaminated feed to a desalination apparatus including a membrane;
rotating the desalination separator during said providing;
removing permeate water from the desalination separator; and
removing reject water from the separator.

15. A separation system, comprising:
a membrane separator that separates a feed into a component and a waste; and
a connector connected to the membrane separator, wherein the membrane separator is rotatable while the membrane separator is separating.

16. The separation system of claim 15, wherein the membrane separator includes a spiral wound membrane.

17. The separation system of claim 16, wherein the spiral wound membrane is rotatable in a direction opposite a winding direction of the spiral wound membrane.

18. The separation system of claim 15, wherein the membrane separator rotates due to the momentum of the feed.

19. The separation system of claim 15, further comprising:
a turbine blade connected to the membrane separator, wherein the membrane separator rotates due to the feed impacting the turbine blade.

20. The separation system of claim 15, further comprising:
a motor connected to the membrane separator, wherein the motor rotates the membrane separator.

21. The separation system of claim 15, wherein the membrane separator is rotated using two or more of the group consisting of: momentum from the motion of the feed, a turbine blade connected to the membrane separator, and a motor connected to the membrane separator.

22. The separation system of claim 21, wherein the membrane separator is rotatable in a first direction during a first period of separating, and wherein the membrane separator is rotatable in an opposite direction from the first direction during a second period.

23. The method of claim 22, wherein the membrane separator alternates the direction of rotation between the first direction and the opposite direction on a periodicity.
